(19) United States
(12) Patent Application Publication
(10) Pub. No.: US 2025/0145287 A1
(43) Pub. Date: May 8, 2025

(54) ATTACHMENT FOR AN AMPHIBIOUS AIRCRAFT

(71) Applicant: MY ATG AIRCRAFT TECHNOLOGIES GROUP INC., Lake Country (CA)

(72) Inventor: Jamie LOGIE, Lake Country (CA)

(21) Appl. No.: 18/707,347

(22) PCT Filed: Nov. 4, 2022
(86) PCT No.: PCT/CA2022/051631

§ 371 Date: May 3, 2024

Related U.S. Application Data
(60) Provisional application No. 63/276,255, filed on Nov. 5, 2021.

(51) Int. Cl. B64C 35/00; B64C 25/56

(52) U.S. Cl. CPC B64C 35/002; B64C 25/56; B64C 35/005; B64C 35/008

(57) ABSTRACT

An attachment for an aircraft. The attachment comprises a single, central float portion positioned under a centre of the aircraft, and a retraction apparatus. One end of the retraction apparatus is attached to the float portion and another end of the retraction apparatus is attached to the underside of the aircraft. The retraction apparatus is deployable and retractable between a first and second configuration, such that, with the retraction apparatus in the first configuration, the float portion is retracted towards the aircraft fuselage and, with the retraction apparatus in the second configuration, the float portion is deployed away from the aircraft fuselage. When the float portion is deployed, the float portion allows the aircraft to land on a body of water. When the float portion is retracted, the aircraft is able to land on a ground surface. The attachment can be retrofit to an existing non-amphibious aircraft.

### TECHNICAL FIELD

The present invention relates to aircraft. More specifically, the present invention relates to an attachment for enabling amphibious conversion of an aircraft.

### BACKGROUND

Aircraft that can safely land on and take off from bodies of water (i.e., “seaplanes”) can allow significant flexibility to aviators in regions with many such bodies of water. However, many seaplanes are not able to safely land on (or take off from) ground surfaces. Similarly, many aircraft designed for ground take-off and landing (which may be referred to as “landplanes”) are unable to safely navigate waterways.

Some aircraft have float kits available which can be installed by a landplane operator. That is, some landplanes can be retrofitted with floats/pontoons, to allow for water landings. However, not all such floats allow for landing on runways. That is, once the floats are installed on a landplane, in many cases, landing on ground surfaces is not possible, until and unless the floats are removed. Conventional floats are also fixed in position, resulting in decreased aerodynamic performance during flight.

Additionally, most conventional floats, even removable ones, do not allow for take off and landing from different surfaces in a single flight That is, conventional float systems are not deployable/retractable during flight. For example, the retractable amphibious pontoon technology covered by U.S. Pat. No. 6,866,224 discloses the use of dual retractable pontoons that extend to either side and below an aircraft, once installed. However, because of the positioning of the aircraft wheels and the pontoons, the aircraft disclosed in this reference is not able to take off and land on different surfaces in the same flight (i.e., this plane cannot take off from a ground surface and land on water, or vice versa). Additionally, this dual retractable pontoon attachment is relatively heavy.

Thus, there is a need for an attachment that can enable amphibious conversion of an aircraft and that reduces loss of aerodynamic performance compared to conventional floats.

### SUMMARY

This document discloses an attachment for an aircraft. The attachment comprises a single, central float portion positioned under a centre of the aircraft, and a retraction apparatus. One end of the retraction apparatus is attached to the float portion and another end of the retraction apparatus is attached to the underside of the aircraft. The retraction apparatus is deployable and retractable between a first and second configuration, such that, with the retraction apparatus in the first configuration, the float portion is retracted towards the aircraft fuselage and, with the retraction apparatus in the second configuration, the float portion is deployed away from the aircraft fuselage. When the float portion is deployed, the float portion allows the aircraft to land on a body of water. When the float portion is retracted, the aircraft is able to land on a ground surface. The attachment can be retrofit to an existing non-amphibious aircraft.

In a first aspect, this document discloses an attachment for an aircraft, said attachment comprising: a float portion; and a retraction apparatus, wherein a first end of said retraction apparatus is attached to said float portion and a second end of said retraction apparatus is attached to said aircraft, wherein said retraction apparatus is deployable from a first configuration to a second configuration and retractable from said second configuration to said first configuration, wherein, when said retraction apparatus is in said first configuration, said float portion is in a retracted position, wherein, when said retraction apparatus is in said second configuration, said float portion is in a deployed position, and wherein, when said float portion is in said deployed position, said float portion allows said aircraft to land on a body of water.

In another embodiment, this document discloses an attachment wherein longitudinal axes of said float portion and said aircraft lie in a same vertical plane, said vertical plane being orthogonal to a plane defined by wings of said aircraft.

In another embodiment, this document discloses an attachment wherein said aircraft is a landplane.

In another embodiment, this document discloses an attachment wherein said attachment is retrofitted to said landplane.

In another embodiment, this document discloses an attachment further comprising at least a pair of stabilizers, wherein, when said pair of stabilizers is deployed, one of said pair of stabilizers is at a first side of said float portion and another of said pair of stabilizers is at a second side of said float portion, said first side being opposite said second side, wherein each of said pair of stabilizers is elongated, and wherein longitudinal axes of said pair of stabilizers lie in a same horizontal plane, said horizontal plane being parallel to a plane defined by wings of said aircraft.

In another embodiment, this document discloses an attachment wherein said stabilizers are inflatable.

In another embodiment, this document discloses an attachment wherein said stabilizers automatically inflate when said float portion is deployed and wherein said stabilizers automatically deflate when said float portion is retracted.

In another embodiment, this document discloses an attachment wherein said stabilizers are retractable from said first side and from said second side of said float portion, and wherein, when said stabilizers are retracted, said stabilizers are disposed at a rear of said float portion.

In another embodiment, this document discloses an attachment wherein said retraction apparatus comprises a support structure.

In another embodiment, this document discloses an attachment wherein said support structure comprises at least one front strut and at least one rear strut, wherein said at least one front strut is attached to said top side of said float portion and to said underside of said aircraft towards a front of said aircraft, and wherein said at least one rear strut is attached to said top side of said float portion and to said underside of said aircraft towards a rear of said aircraft.

In another embodiment, this document discloses an attachment wherein said at least one front strut comprises a front pair of struts and said at least one rear strut comprises a rear pair of struts.

In another embodiment, this document discloses an attachment further comprising a stabilizing strut, wherein an end of said stabilizing strut is attached to said underside of said aircraft and another end of said stabilizing strut is attached to said rear strut.

In another embodiment, this document discloses an attachment wherein said retraction apparatus is lockable in said deployed configuration.

In another embodiment, this document discloses an attachment wherein a retraction and a deployment of said retraction apparatus are controlled by at least one of: an electric motor system: a hydraulic system; and a manual pump.

In another embodiment, this document discloses an attachment wherein said retraction and said deployment are also controllable by a secondary motor system.

In another embodiment, this document discloses an attachment wherein said secondary motor system is a manual pump.

In another embodiment, this document discloses an attachment further comprising a rudder, said rudder being attached at a rear of said float portion.

In another embodiment, this document discloses an attachment wherein said rudder is deployable from and retractable into said float portion.

In another embodiment, this document discloses an attachment further comprising at least one shock absorber.

In another embodiment, this document discloses an attachment wherein, when said float portion is in said deployed position, said aircraft is also able to land on a ground surface.

In another embodiment, this document discloses an attachment wherein, when said retraction apparatus is in a third configuration, said float portion is in an intermediate position, and wherein, when said float portion is in said intermediate position, said float portion is closer to said aircraft than when said float portion is in said deployed position and said float portion is farther from said aircraft than when said float portion is in said retracted position.

In another embodiment, this document discloses an attachment wherein: when said retraction apparatus transitions from said first configuration to said third configuration, said float portion deploys from said retracted position to said intermediate position: when said retraction apparatus transitions from said third configuration to said second configuration, said float portion deploys from said intermediate position to said deployed position: when said retraction apparatus transitions from said second configuration to said third configuration, said float portion retracts from said deployed position to said intermediate position; and when said retraction apparatus transitions from said third configuration to said first configuration, said float portion retracts from said intermediate position to said retracted position.

### BRIEF DESCRIPTION OF THE DRAWINGS

The present invention will now be described by reference to the following figures, in which identical reference numerals refer to identical elements and in which:

FIG. 1A is a schematic drawing of a front view of an aircraft with an attachment according to an aspect of the invention:

FIG. 1B is a schematic drawing of a bottom view of the aircraft of FIG. 1A, with another configuration of optional stabilizers;

FIG. 2 is a schematic drawing of a side view of the aircraft and attachment of FIG. 1A, showing the attachment in both retracted and deployed positions:

FIG. 3A is a schematic drawing of a top view of a retraction apparatus according to an aspect of the present invention:

FIG. 3B is a schematic drawing of a side view of the retraction apparatus of the present invention;

FIG. 3C is a schematic drawing of a side view of the retraction apparatus of the present invention, with the retraction apparatus in a retracted configuration; and

FIG. 4 is a schematic image of a float portion of the attachment, showing an implementation with a retractable rudder.

### DETAILED DESCRIPTION

This document discloses an attachment for enabling amphibious landings by a landplane. That is, this document discloses an attachment that can be retrofitted to an aircraft and that, when deployed, allows the aircraft to land on a body of water. The attachment is retractable towards the fuselage of the aircraft, to mitigate drag and loss of aerodynamic performance during flight and/or for ground landings. The attachment comprises a retraction apparatus connected at one end to a float portion and connected at another end to the underside of the aircraft. The float portion comprises a generally hollow hull suitable for landing on water. The hull may have a prow end and a rear end. When installed, the prow end of the hull of the float portion is disposed towards a nose of the aircraft and the rear end of the hull is disposed towards a tail of the aircraft.

As well, in some embodiments, when the attachment is installed on an aircraft, a longitudinal axis of the float portion and a longitudinal axis of the aircraft lie in the same vertical plane. That is, a centre line of the float portion is aligned with, and not horizontally offset from, a centre line of the aircraft. For clarity, as used in this application, the terms ‘vertical’ and ‘horizontal’, as used herein, refer to relative dimensions of the aircraft with respect to the aircraft's wings. That is, a ‘horizontal plane’ is a plane parallel to a plane defined by the wings of the aircraft, while a ‘vertical plane’ is a plane orthogonal to a plane defined by the wings of the aircraft.

When the retraction apparatus is in a first configuration, the retraction apparatus is retracted close to the underside of the aircraft. As a result, the float portion is also in a retracted position. The retraction apparatus can be deployed from the first configuration to a second configuration. When the retraction apparatus is deployed to the second (e.g., extended) configuration, the float portion is deployed farther away from the aircraft fuselage (i.e., in a deployed position). The retraction apparatus can be securely locked in the second configuration, so that the float position can support the weight and force of a water landing.

The retraction apparatus may have any suitable structure. As would be clear, the requirements for a ‘suitable’ structure in this context are that the retraction apparatus be deployable/retractable, lockable in the deployed configuration, and sufficiently strong to withstand the force of a water landing. As well, it is preferred that the retraction apparatus be lockable in the retracted configuration. It is also preferred that the retraction apparatus be relatively lightweight. Of course, the possible range of weights depends upon multiple factors, including the type of aircraft, etc.

In some embodiments, therefore, the retraction apparatus can be a single support (e.g., an extendable/retractable column). However, such a single support might not satisfy the requirements listed above. Thus, in some embodiments, the retraction apparatus comprises a support structure (i.e., a deployable/retractable structure comprising multiple interconnected supports). The support structure can comprise multiple supports/struts that interact with each other and are preferably hinged together to allow for compact retraction to the retracted configuration.

The retraction and deployment of the retraction apparatus is, in some embodiments, controlled by at least one motor or pump, such as an electric pump and/or a hydraulic pump, operable from within the aircraft. As well, in some embodiments, at least one secondary motor system is provided. For example, the secondary motor system can be a manual pump system. Multiple secondary systems may of course be provided.

The retraction apparatus also, in some embodiments, comprises a suspension system (e.g., at least one shock-absorbing mechanism). Such a suspension system, as is well-understood, would reduce the effect of landings. The suspension system may take the form of one or more spring-based shock absorbers attached to the retraction apparatus.

As well, in some embodiments, the retraction apparatus also has a ‘partially deployed’ configuration. When the retraction apparatus is in the partially deployed configuration, the float portion is in an intermediate position (i.e., farther from the aircraft fuselage than in the retracted position, but not as far from the aircraft fuselage as when in the deployed position). The float portion can be deployed from the retracted position to the intermediate position, and from the intermediate position to the (fully) deployed position. Similarly, the float portion can be retracted from the (fully) deployed position to the intermediate position, and from the intermediate position to the retracted position. The partially deployed position, as would be clear, is suitable for water take-offs/embarking and landings. In some embodiments, the retraction apparatus is lockable in the partially deployed configuration and may be suitable for landing on ground surfaces (e.g., in coordination with deployed landing gear). That is, in some embodiments, the partially deployed configuration is adapted for wheel landings (i.e., landings on ground surfaces). In such embodiments, the float portion is preferably fully retracted during flight, partially deployed for ground landings/wheel landings, and fully deployed for and during water landings. Of course, the particular configuration(s) of the retraction apparatus/positions of the float portion that are suitable for any particular aircraft and/or use can be determined based on specific requirements.

In some embodiments, the attachment further comprises at least a pair of stabilizers. The stabilizers are positioned at opposite sides of the float portion (e.g., at left and right sides of the hull of the float portion). The stabilizers are preferably elongated, and longitudinal axes of all of the stabilizers preferably lie in the same horizontal plane (i.e., in a plane parallel to the plane defined by the wings). In one embodiment, stabilizers extend outwards from sides of the float portion (i.e., outwards from the central longitudinal axis of the aircraft). Alternatively and/or additionally, stabilizers extend from the underside of the aircraft's wings. However, depending on the embodiment, other shapes of stabilizers can be used (for example, round stabilizers can be used in suitable embodiments). Additionally, although at least two opposing stabilizers are generally needed, other combinations of stabilizers can be used. For instance, in some embodiments, a float portion may have a single elongated stabilizer extending from its left side and two round stabilizers extending from its right side. Any and all such configurations are intended to fall within the scope of the invention herein described.

The configuration of the stabilizers is preferably not static (i.e., the stabilizers are not always deployed). In some embodiments, the stabilizers are inflatable. In other embodiments, the stabilizers are not inflatable but are retractable/deployable from the rear of the float portion. Stabilizers that are only deployed when needed and retracted/deflated when not needed can help to reduce drag and loss in aerodynamic performance, in comparison to seaplanes and/or float planes that have static stabilizers. As well, the stabilizers are preferably suitable as platforms that allow passengers of the aircraft to enter and exit the aircraft.

In preferable embodiments, the stabilizers are automatically inflated/deployed. That is, their deployment does not require manual input. Similarly, the stabilizers are, in some embodiments, automatically deflated/retracted. For example, inflatable stabilizers are, in some embodiments, automatically inflated upon or during landing in water, and automatically deflated upon or during takeoff. In some embodiments, the stabilizers are fully deployed and/or inflated before the water landing. Of course, for safety reasons, even in embodiments in which the stabilizers are automatically inflated, it is preferred to have a manual backup inflation option.

Inflatable stabilizers are stowed in the centre of the float portion (i.e., in the generally hollow space within the hull of the float portion), and, when inflated, can extend outwards through apertures in the sides of the float portion or over the edges of the float portion. Retractable/non-inflatable stabilizers are, in one implementation, mounted on a swing mechanism that attaches to the float portion. When retracted, these retractable/non-inflatable stabilizers are disposed behind the float portion (i.e., towards the tail end of the aircraft and retracted towards the fuselage), which mitigates loss of aerodynamic performance. In further embodiments, the aircraft has multiple types of stabilizers. For example, in one embodiment, the attachment comprises inflatable stabilizers that fully deploy before water landings and also comprises additional mechanically retracted/deployed stabilizers that deploy during a water landing.

The aircraft's landing gear, in some embodiments, is immersed in water during water landings. In other embodiments, including without limitation where the landing gear is retractable, the landing gear can be protected from immersion in the water during water landings. Additionally, as mentioned above, in some embodiments, the float portion is configured to deploy to an intermediate (i.e., not fully deployed) position. Preferably, in the intermediate position, the bottom of the float portion is higher than the landing gear of the aircraft, to facilitate wheel landings using the aircraft's suspension.

The specific dimensions and materials of the attachment depend on the desired aircraft to be retrofitted, as well as on various parameters such as the use of the aircraft in question. For instance, a lightweight recreational aircraft may require a comparatively lightweight attachment while a larger aircraft to be used in firefighting, or for multi-person transport, may require a heavier and/or stronger attachment, suitable for heavier duty. In some embodiments, materials such as carbon-fiber and/or composites (including, e.g., epoxy composites) form the float portion. Of course, different components of the attachment may comprise different materials. In one embodiment, the float portion is primarily constructed from composite material, with some structural aluminum for strength (e.g., at connection points to the aircraft and/or to the retraction apparatus). The retraction apparatus, in some embodiments, comprises welded metal tubing (as a non-limiting example, tubing made of low alloy steels, such as chromoly) and plating to accommodate the landing loads on water or on land. The inflatable (and/or retractable/non-inflatable) stabilizers comprise, in some embodiments, rubber and/or foam-type floatation material. Of course, again, any suitable materials can be used.

In a preferable embodiment, the weight of the float portion is approximately equal to the weight of the structure of the retraction apparatus. Similarly, the weight of the electronic/motive components is preferably approximately equal to the weight of the float portion (and thus also to the weight of the structure of the retraction apparatus). Of course, the person skilled in the art can determine suitable materials and dimensions for any particular aircraft and/or desired use.

Further, in some embodiments, the attachment is strong enough to withstand landing on a ground surface with the float portion in the deployed position. For example, if the float portion were mistakenly deployed, or if an emergency landing is needed, it is preferable that the attachment be able to withstand the impact with minimal damage. Of course, there may be a necessary trade-off between the strength of the attachment/float portion and the weight of the attachment. Again, the person skilled in the art would understand how to adjust the various materials and dimensions used for any specific attachment/aircraft combination.

In some embodiments, further, a rudder is attached to the float portion. The rudder extends from the rear end of the float portion, and is connected to a steering mechanism operable from inside the aircraft (e.g., rudder paddles), to control the steering of the aircraft in water. The steering mechanism may include existing steering mechanisms and/or retrofitted steering mechanism. The rudder is, in some embodiments, deployable from and retractable into the float portion. Retracting the rudder during flight may improve aerodynamics, in comparison to embodiments in which the rudder does not retract. In one embodiment, the rudder retracts or deploys when the float portion retracts or extends, through an automatic mechanism. In such embodiments, the rudder is only fully deployed when the float portion is fully deployed. Preferably, the rudder only enters water when the aircraft has slowed enough for the float portion to settle and displace safely into the water. In other embodiments, the rudder is attached to a tail wheel of the aircraft and is not deployable/retractable.

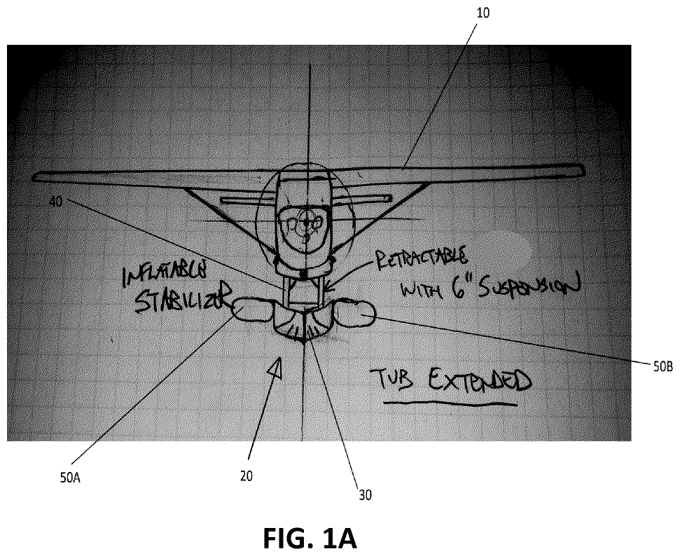

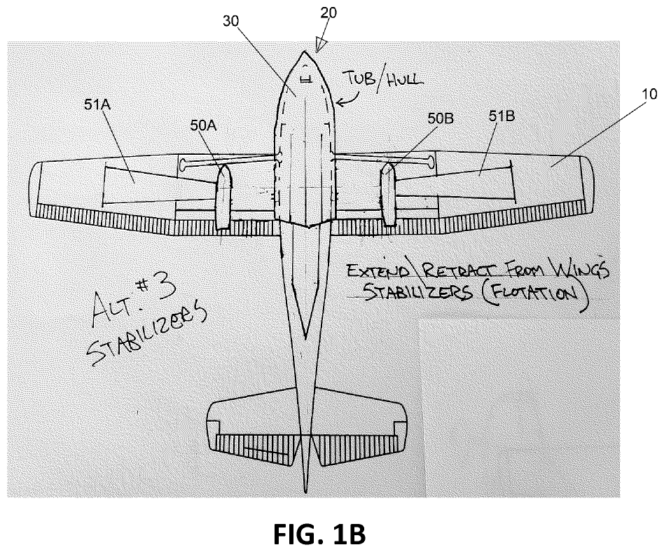

Referring now to FIG. 1A, a schematic drawing of an aircraft 10 is shown. The aircraft 10 has an installed attachment 20. The attachment comprises a float portion 30 and a retraction apparatus 40. Inflatable stabilizers 50A and 50B extend from either side of the float portion 30.

FIG. 1B is a schematic drawing of the underside of the aircraft 10 of FIG. 1B. As should be clear, the retraction apparatus 40 is not visible in this bottom view. Further, in the embodiment of the attachment shown in FIG. 1B, stabilizers 50A and 50B extend and retract from the underside of the wings of the aircraft 10 using stabilizer retraction apparatus 51A, 51B. As discussed above, stabilizers that extend at the sides of the float portion/hull 30 may extend directly from the sides of the float portion/hull 30, from the underside of the wings, or both, depending on the embodiment. Further, again, in some embodiments, no stabilizers are present.

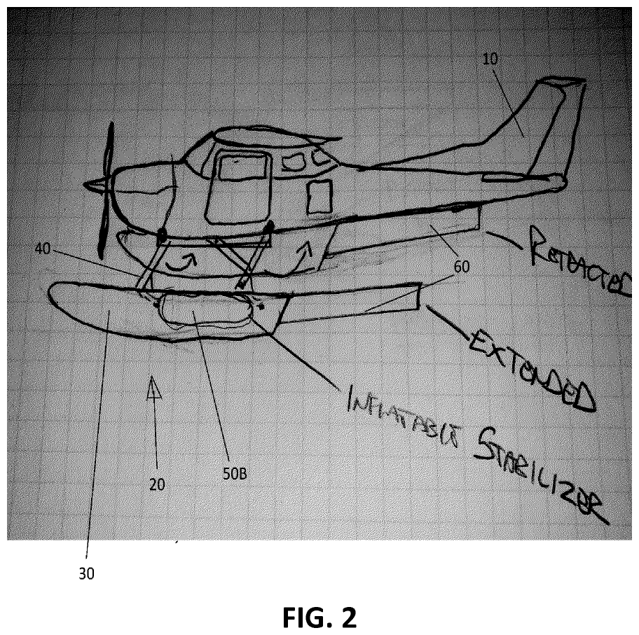

FIG. 2 is a schematic side view of the aircraft 10 and attachment 20 of FIG. 1A. In this embodiment, the float portion/hull 30 has both inflatable stabilizers (e.g., 50B) and alternative, non-inflatable stabilizers 60. The non-inflatable stabilizers 60, as discussed above, could swing forward and out (i.e., towards the sides of the float portion 30) when deployed. The non-inflatable stabilizers 60 are, depending on the embodiment, automatically deployed and/or automatically deployed under certain conditions. As a non-limiting example, the non-inflatable stabilizers can be used in some embodiments to assist aircraft in water maneuvering and rough water situations.

The arrows in this FIG. 2 (directly under the aircraft 10) indicate the ‘retracting’ direction of the attachment. That is, in this embodiment, when the retraction apparatus 40 retracts, the float portion 30 is retracted upwards and towards the tail of the aircraft. Conversely, when the retraction apparatus 40 deploys, the float portion 30 is deployed downwards and towards the nose of the aircraft.

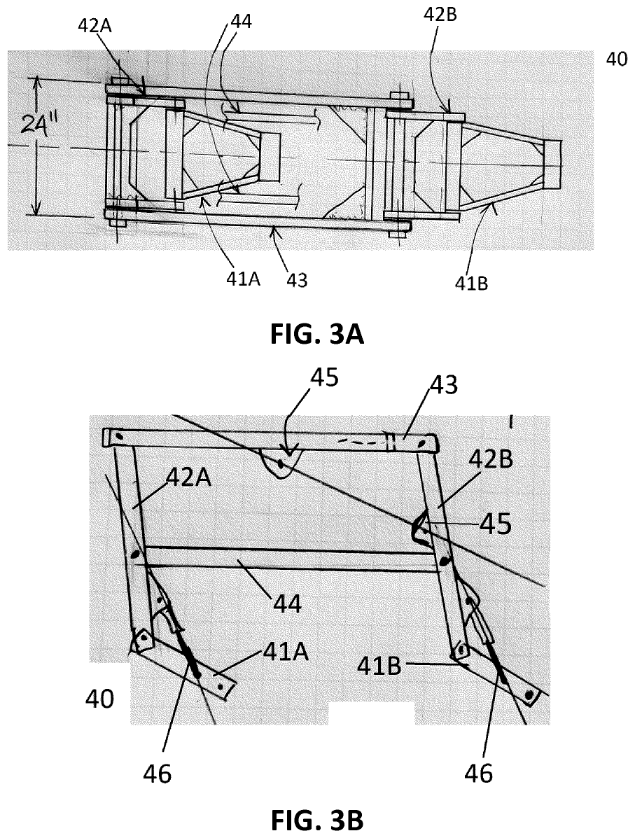

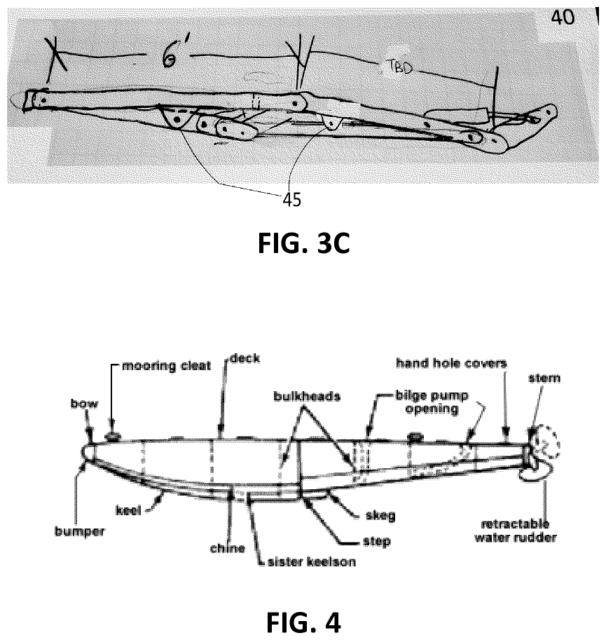

FIG. 3A is a schematic of a retraction apparatus 40. In this embodiment, the retraction apparatus comprises multiple arms/struts. That is, the retraction apparatus comprises a front pair of suspension arms 41A and a rear pair of suspension arms 41B. The front pair of suspension arms 41A is connected to a front pair of swing arms/struts 42A. The rear pair of suspension arms 41B is connected to a swing arms/struts 42B. The front pair of swing arms/struts 42A and the rear pair of swing arms/struts 42B are connected, at their respective other ends, to longitudinal mounts 43, which are mounted on the underside of the aircraft. Connecting struts 44, shown in a partial view in this figure, connect the swing arms/struts to the float portion 30 (not shown). Although this FIG. 3A indicates a scale (i.e., a distance of 24 inches/2 feet/0.6096 m) between the outer edges of the retraction apparatus, it should again be noted that attachments of any suitable dimensions may be used for each aircraft fitted with such attachments.

FIG. 3B is a schematic side view of the retraction apparatus of FIG. 3A, in the second (deployed) configuration. In this figure, lugs 45 for mounting retraction/deployment actuators (not shown) can be seen on the mount 43 and the strut 42B. The line between the lugs 45 shows the longitudinal axis of such an actuator (when mounted, again not shown in this figure). Additionally, spring and gas shocks 46 can be seen on both the front pair of suspension arms 41A and the rear pair of suspension arms 41B.

FIG. 3C is a schematic of the retraction apparatus of FIG. 3A, in the first (retracted) configuration. As can be seen, the retraction apparatus folds into itself, taking up relatively little volume in the first (retracted) configuration. Again, although some dimensions are noted in this image, it should be clear that any suitable dimensions may be selected depending on the desired implementation.

FIG. 4 is a schematic of a float portion/hull according to an aspect of the present invention. This hull has a single rudder installed at the rear of the hull, and may use a motor or a spring release-and-retract mechanism to extend the rudder in the water for the pilot to maneuver as desired. Multiple other installations could aid in better control for in water use if a single rudder is used. Of course, in addition to the single-rudder embodiment described above, multiple rudders can be used in some embodiments. In a preferred embodiment, the material forming the rudder(s) is a lightweight and comparatively corrosion-resistant material such as an aluminum alloy.

As well, as seen in FIG. 4, a skeg can be placed near the rear of the hull, specifically after a step of the hull, would stop the float from tipping on the rear of the hull in water, especially at faster speeds. Float portions featuring a step in the hull (i.e., an abrupt change of the pitch of the keel) can also allow for better aerodynamics during flight, as the skeg would be protected by the step and thus not affect airflow. Such a step in the hull can also aid in the landing process, by reducing drag from the water and, thus, allowing for more mobility. However, adjustments to the wheel arrangements may be required to account for the step and/or skeg. In some embodiments, a standard keel is also used along the centerline of the hull to create more straight-line stability through water and to reinforce the structure. The float portion, as would be understood by the person of skill in the art, could have the characteristics of any conventional float or hull, including without limitation chines, steps, and/or reinforcing to accommodate both water and mechanical loads. Manufacture of such a float portion could include, without limitation, a combination of aircraft and/or nautical construction methods.

A person understanding this invention may now conceive of alternative structures and embodiments or variations of the above all of which are intended to fall within the scope of the invention as defined in the claims that follow.

We claim:

1. An attachment for an aircraft, said attachment comprising:
a float portion; and
a retraction apparatus,
wherein a first end of said retraction apparatus is attached to said float portion and a second end of said retraction apparatus is attached to said aircraft,
wherein said retraction apparatus is deployable from a first configuration to a second configuration and retractable from said second configuration to said first configuration,
wherein, when said retraction apparatus is in said first configuration, said float portion is in a retracted position,
wherein, when said retraction apparatus is in said second configuration, said float portion is in a deployed position,
and wherein, when said float portion is in said deployed position, said float portion allows said aircraft to land on a body of water.

2. The attachment according to claim 1, wherein longitudinal axes of said float portion and said aircraft lie in a same vertical plane, said vertical plane being orthogonal to a plane defined by wings of said aircraft.

3. The attachment according to claim 1, wherein said aircraft is a landplane.

4. The attachment according to claim 3, wherein said attachment is retrofitted to said landplane.

5. The attachment according to claim 1, further comprising at least a pair of stabilizers, wherein, when said pair of stabilizers is deployed, one of said pair of stabilizers is at a first side of said float portion and another of said pair of stabilizers is at a second side of said float portion, said first side being opposite said second side, wherein each of said pair of stabilizers is elongated, and wherein longitudinal axes of said pair of stabilizers lie in a same horizontal plane, said horizontal plane being parallel to a plane defined by wings of said aircraft.

6. The attachment according to claim 5, wherein said stabilizers are inflatable.

7. The attachment according to claim 6, wherein said stabilizers automatically inflate when said float portion is deployed and wherein said stabilizers automatically deflate when said float portion is retracted.

8. The attachment according to claim 5, wherein said stabilizers are retractable from said first side and from said second side of said float portion, and wherein, when said stabilizers are retracted, said stabilizers are disposed at a rear of said float portion.

9. (canceled)

10. The attachment according to claim 1, wherein said retraction apparatus comprises a support structure.

11. The attachment according to claim 10, wherein said support structure comprises at least one front strut and at least one rear strut, wherein said at least one front strut is attached to a top side of said float portion and to said underside of said aircraft towards a front of said aircraft, and wherein said at least one rear strut is attached to said top side of said float portion and to said underside of said aircraft towards a rear of said aircraft.

12. The attachment according to claim 11, wherein said at least one front strut comprises a front pair of struts and said at least one rear strut comprises a rear pair of struts.

13. (canceled)

14. The attachment according to claim 1, wherein said retraction apparatus is lockable in a deployed configuration.

15. The attachment according to claim 1, wherein a retraction and a deployment of said retraction apparatus are controlled by at least one of: an electric motor system; a hydraulic system; and a manual pump.

16. The attachment according to claim 15, wherein said retraction and said deployment are also controllable by a secondary motor system.

17. The attachment according to claim 16, wherein said secondary motor system is a manual pump.

18. The attachment according to claim 1, further comprising a rudder, said rudder being attached at a rear of said float portion.

19. (canceled)

20. The attachment according to claim 1, further comprising at least one shock absorber.

21. The attachment according to claim 1, wherein, when said float portion is in said deployed position, said aircraft is also able to land on a ground surface.

22. The attachment according to claim 1, wherein, when said retraction apparatus is in a third configuration, said float portion is in an intermediate position, such that said float portion is closer to said aircraft than when said float portion is in said deployed position and said float portion is farther from said aircraft than when said float portion is in said retracted position.

23. The attachment according to claim 22, wherein:
when said retraction apparatus transitions from said first configuration to said third configuration, said float portion deploys from said retracted position to said intermediate position;
when said retraction apparatus transitions from said third configuration to said second configuration, said float portion deploys from said intermediate position to said deployed position;
when said retraction apparatus transitions from said second configuration to said third configuration, said float portion retracts from said deployed position to said intermediate position; and
when said retraction apparatus transitions from said third configuration to said first configuration, said float portion retracts from said intermediate position to said retracted position.
